(19) United States
(12) Patent Application Publication
(10) Pub. No.: US 2003/0234358 A1
(43) Pub. Date: Dec. 25, 2003

(54) Piezo-noise microscope and methods for use thereof

(75) Inventors: Mark J. Higgins, Cranbury, NJ (US); Sabyasachi Bhattacharya, New York, NY (US); Ajit Krishnan, Harleysville, PA (US)

Correspondence Address: PHILIP J FEIG, NEC RESEARCH INSTITUTE INC, 4 INDEPENDENCE WAY, PRINCETON, NJ, 08540

(73) Assignee: NEC Research Institute, Inc., Princeton, NJ

(21) Appl. No.: 10/210,840

(22) Filed: Jul. 31, 2002

Related U.S. Application Data
(60) Provisional application No. 60/390,862, filed on Jun. 20, 2002.

(51) Int. Cl. G01N 13/10; G12B 21/20

(52) U.S. Cl. 250/306; 250/307; 73/105

(57) ABSTRACT

A piezo-noise microscope for use in examining a sample of piezoelectric material is provided. The piezo-noise microscope improves on existing atomic force microscope (AFM) techniques by generating piezoresponse noise signals which are useful for determining the long-term polarization stability of piezoelectric materials, and in particular ferroelectric materials, without the need to make repeated observations over extended periods of time. A method for detecting piezo-response noise in a sample of piezoelectric material using a piezo-noise microscope, and a method for detecting the stability of polarization in regions of a sample of piezoelectric material, are also provided.

### CROSS-REFERENCE TO RELATED APPLICATION

This application claims the benefit of United States Provisional Application No. 60/390,862, filed Jun. 20, 2002, which is incorporated herein for all purposes.

### FIELD OF THE INVENTION

The present invention relates to the field of atomic force microscopy, and in particular to a piezo-noise microscope for use in examining piezoelectric materials, including in particular ferroelectric materials.

### BACKGROUND OF THE INVENTION

The field of scanning probe microscopy began with the invention of the scanning tunneling microscope in 1985 by Rohrer and Binning. See G. Binning et al., “Surface Studies by Scanning Tunneling Microscopy,” Physical Review Letters, vol. 49, no. 1, pp. 57-61 (Jul. 5, 1982). In this device, a small metallic cantilevered probe tip is scanned in a raster pattern over the surface of a metallic sample. The tunneling current is monitored as a function of the probe tip's proximity to the surface, and the surface topography is correspondingly mapped. This technique has been extended to non-conducting samples with the development of the atomic force microscope (“AFM”). See G. Binning et al., “Atomic Force Microscope,” Physical Review Letters, vol. 56, no. 9, pp. 930-933 (Mar. 3, 1986).

A number of scanning probe techniques have been developed based on the AFM. One such technique is the piezoresponse imaging mode. See H. Birk et al., “The Local Piezoelectric Activity of Thin Polymer Films Observed by Scanning Tunneling Microscopy,” Journal of Vacuum Science & Technology B, vol. 9, no. 2, pp. 1162-1165 (March/April 1991); P. Guthner et al., “Local Poling of Ferroelectric Polymers by Scanning Force Microscopy,” Applied Physics Letters, vol. 61, no. 9, pp. 1137-1139 (Aug. 31, 1992); K. Franke et al., “Modification and Detection of Domains on Ferroelectric PZT Films by Scanning Force Microscopy,” Surface Science Letters, vol. 302, pp. L283-L288 (1994). In this mode, the AFM cantilevered probe tip is used as a moving top electrode scanned in contact with the surface of a ferroelectric sample. An oscillatory voltage is applied between the metallic cantilever and a bottom electrode of the sample.

AFM techniques have been applied to ferroelectric materials. Ferroelectric materials are also piezoelectric, so a ferroelectric sample deforms mechanically when examined in an AFM system in response to the applied voltage. The deformations are detected by the AFM optics, and the detected signal is fed into a demodulator, which is typically a lock-in-amplifier. The lock-in-amplifier then resolves the phase and amplitude of the piezoresponse. The phase gives the sign of the local polarization, and the amplitude is proportional to the local piezoelectric coefficient d₃₃. Thus a completed scan produces an image of the strength (amplitude) and sign (phase) of the polarization over the scan area.

FIG. 1A and 1B show examples of such images. Dark regions denote domains of down polarization and bright regions are up oriented domains. The boundaries between domains are called domain walls. Domain walls are transition regions between areas of different polarization. Domain walls can be pinned by defects and impurities in ferroelectric materials. Pinned domain walls generally give stable domains. In the amplitude image example of FIG. 1A, the amplitude is seen to decrease at the domain walls.

For applications of ferroelectric thin films such as non-volatile computer memory, it is important that domains in the ferroelectric thin film retain their polarization (i.e. are stable) for long periods of time. The stability of individual domains can be affected by factors such as grain size, film processing techniques, film thickness, substrate material and film composition. IN memory applications in particular, stability depends on writing voltage, the amount of time the voltage is applied, temperature, material characteristics and the like.

Accordingly, it would be desirable to provide systems and techniques for assessing the long-term stability of ferroelectric materials on a microscopic level without having to make repeated observations over extended periods of time.

### SUMMARY OF THE INVENTION

Generally speaking, the invention includes a piezo-noise microscope for use in examining a sample of piezoelectric material. The piezo-noise microscope includes an electrically conductive support for supporting the sample and a probe comprising a cantilever and an electrically conductive probe tip on a free end of the cantilever. The probe tip is positionable in contact with a surface of the sample and is deflectable in response to mechanical deformation of the sample caused by a piezoelectric effect. An oscillator is electrically coupled to the support and the probe and provides an oscillating electrical signal thereto. A tip deflection detector is provided which provides a tip deflection signal corresponding to deflection of the probe tip. A demodulator is also provided and is configured to provide at least one piezoresponse signal based on the oscillating electrical signal and the tip detection signal. The piezo-noise microscope further includes a filter for filtering the piezoresponse signal and an amplifier for amplifying the filtered piezoresponse signal to provide a piezoresponse noise signal.

The invention also includes a method for detecting piezo-response noise in a sample of piezoelectric material using a piezo-nolse microscope including a probe having an electrically conductive probe tip provided on a free end of a cantilever and positioned in contact with a surface of the sample. The method comprises: (a) applying an oscillating electrical signal between the sample and the probe tip such that the sample mechanically deforms due to a piezoelectric effect, thereby deflecting the probe tip; (b) detecting deflection of the probe tip; (c) providing a tip deflection signal corresponding to deflection of the probe tip; (d) demodulating the oscillating electrical signal and the tip detection signal to provide at least one piezoresponse signal; (e) filtering the piezoresponse signal; and (f) amplifying the filtered piezoresponse signal to provide a piezoresponse noise signal.

The piezoresponse noise signals generated by the piezo-noise microscope and method are useful for determining the long-term stability (that is, the ability of the material to retain its polarization for long periods of time) of piezoelectric materials, and in particular ferroelectric materials, in a straightforward and efficient manner and without the need to make repeated observations over extended periods of time.

The invention thus further includes a method for detecting the stability of polarization in regions of a sample of piezoelectric material. The method comprises the steps of: (a) mechanically deforming the sample by inducing a piezoelectric response in the sample; (b) detecting the piezoelectric response; (c) detecting noise within a predetermined range of frequencies in the piezoelectric response; and (d) determining the stability of regions of the sample in accordance with the level of noise associated with such regions.

### BRIEF DESCRIPTION OF THE DRAWINGS

FIGS. 1A and 1B are time-averaged amplitude and phase images, respectively, provided by a standard atomic-force microscope operating in piezoresponse imaging mode on a lead zirconium titinate (“PZT”) thin film sample, wherein arrows indicate location of domain walls separating regions of opposite polarization in the sample;

FIG. 2 is a schematic diagram of a piezo-noise microscope constructed in accordance with the present invention;

FIG. 3A is an exemplary topography image provided by a standard atomic force microscope;

FIG. 3B is an exemplary time-averaged phase image provided by a standard atomic force microscope;

FIG. 3C is an exemplary phase noise image provided by the piezo-noise microscope of the present invention;

FIG. 3D is an exemplary amplitude image provided by a standard atomic force microscope; and

FIG. 3E is an exemplary amplitude noise image provided by the piezo-noise microscope of the present invention;

FIG. 4 is a flow diagram illustrating a method for detecting piezo-response noise in a sample of piezoelectric material according to the present invention using the piezo-noise microscope of the present invention; and

FIG. 5 is a flow diagram illustrating a method for detecting the stability of polarization in regions of a sample of piezoelectric material according to the present invention.

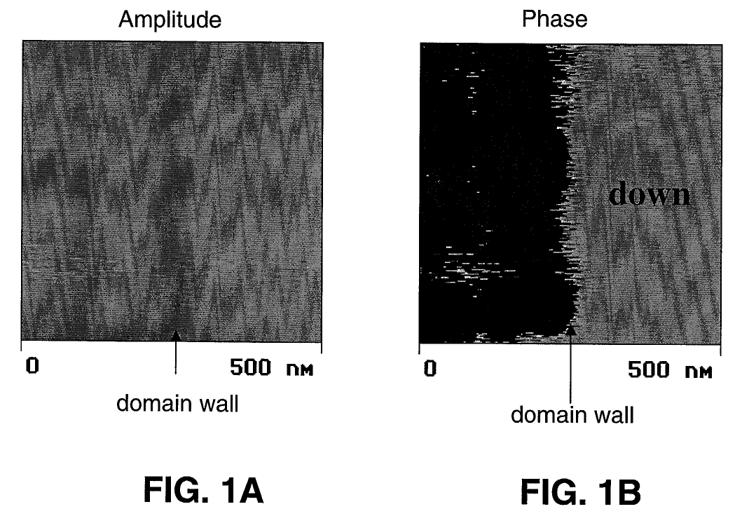

### DETAILED DESCRIPTION OF THE PREFERRED EMBODIMENTS

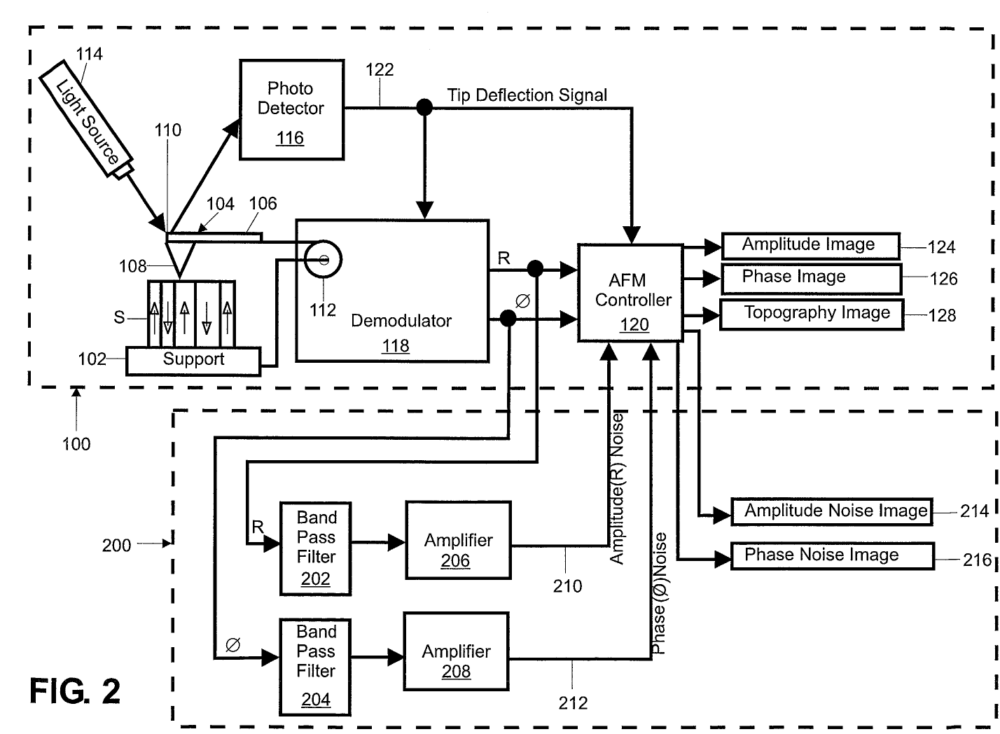

Generally speaking, FIG. 2 schematically illustrates a piezo-noise microscope according to the present invention. The piezo-noise microscope includes a standard atomic force microscope 100 operating in piezoresponse imaging mode coupled with a novel noise signal generating unit 200.

The atomic force microscope 100 operating in piezoresponse imaging mode is known in the art. Generally speaking, the AFM 100 includes an electrically conductive support 102 for supporting a sample S of piezoelectric material (the thickness of sample S is exaggerated in the figure). The sample S is preferably a ferroelectric material, but may comprise any piezoelectric material in which the piezoelectric effect is observable by the AFM. AFM 100 also includes a probe 104. Probe 104 comprises a metallic cantilever 106, a probe tip 108 on a free end of the cantilever, and an optically reflective portion 110. An oscillator 112 is electrically coupled to the support 102 and the probe 104. AFM 100 further typically includes a light source 114, a photodetector 116, a demodulator 118 and an AFM controller 120. Light source 114, preferably a laser, is directed at the reflective portion 110 of probe 104, such that reflected light is received by photodetector 116. Light source 114, reflective portion 110 of probe 104 and photodetector 116 together comprise a tip deflection detector which detects deflection of probe tip 108. While the reflected light tip deflection detector is preferable, other techniques and configurations for detecting deflection of the probe tip may be used and are envisioned within the scope of the present invention. Photodetector 116 is operatively coupled to demodulator 118 and AFM controller 120. Demodulator 118 is preferably a lock-in amplifier as known in the art, but may include band pass filters with amplitude detection. Demodulator 118 may be digital or analog. AFM controller 120, as is known in the art, controls the position of probe tip 108 on the surface of sample S and correlates various response signals with such position to produce images of signal response correlated with surface position.

AFM 100 operates as follows. Oscillator 112 applies an oscillating electrical signal between support 102 and probe 104. The frequency of the oscillatory signal is preferably between that of the AFM servo electronics (typically a few hundred hertz) and the resonance of the cantilever 106 (typically about 70 kHz); preferably, the frequency of the oscillatory signal is about 10 kHz. The magnitude of the oscillatory signal is preferably less than the coercive voltage of the film, which is the voltage necessary to switch the polarization. Preferably, the magnitude of the voltage of the oscillatory signal is 1-2 Volts rms. By the inverse piezoelectric effect, sample S deforms mechanically (as schematically indicated by the up and down arrows within sample S in FIG. 2) due to the applied oscillatory signal. These deformations deflect cantilevered probe 104, which deflections are detected by the tip deflection detector. Light reflected from the reflective portion 110 of probe 104 is collected by photodetector 116. Consequently, photodetector 116 detects fluctuations in the reflected light which correspond to deflections of probe tip 108, and these deflections are represented by a broadband tip deflection signal 122 which is fed to both demodulator 118 and AFM controller 120. Demodulator 118 demodulates the oscillating electrical signal and the tip deflection signal 122 by using the component of the tip deflection signal at the AC modulation frequency of the oscillator to generate a phase-detected amplitude signal R and a phase-detected phase signal ø as known in the art. The phase-detected amplitude signal R and phase-detected phase signal ø are referred to generally as piezoresponse signals. Preferably, AFM controller 120 determines the average value of the phase-detected amplitude signal R and the phase-detected phase signal ø and correlates these values with the position of the probe tip 108 to generate an amplitude image 124 and a phase image 126 of the sample S. AFM controller 120 also preferably uses the DC component of tip deflection signal 122 to generate a topographic image 128 of the surface of sample S.

It should be noted that while the description herein refers to amplitude and phase signals, various AFM measurement signals can be used as known in the art, and such signals may be used to derive conventional amplitude and phase signals. Accordingly, the amplitude and phase signals referred to herein are intended to be construed as encompassing such other related AFM measurement signals. An example of such other measurement signals is the use of in-phase and quadrature mode signals.

In addition to AFM 100, the piezo-noise microscope of the present invention includes novel noise signal generating unit 200, which measures temporal fluctuations of the phase-detected amplitude and phase signals. The phase-detected piezoresponse signals, namely phase-detected amplitude signal R and the phase-detected phase signal ø, are fed through filters 202 and 204, respectively, to detect the temporal fluctuations within the frequency window allowed by the respective filter. The resulting filtered phase-detected amplitude and phase signals are then each fed to amplifiers 206 and 208, respectively, to obtain root mean square (rms) values of the signals, thereby providing an amplitude noise signal 210 and a phase noise signal 212. The amplitude noise signal 210 and phase noise signal 212 are referred to generally as piezoresponse noise signals. Finally, the amplitude noise signal 210 and phase noise signal 212 are preferably fed back to AFM controller 120 which correlates these signals with the position of the probe tip 108 to generate an amplitude noise image 214 and a phase noise image 216 of the sample S.

The piezo-noise microscope of the present invention is useful with, and encompasses, embodiments in which a single piezoresponse signal is generated or multiple piezoresponse signals are generated. For example, the piezo-noise microscope could be configured to provide only an amplitude noise signal, only a phase noise signal, or both an amplitude noise signal and a phase noise signal.

Filters 202 and 204 may be high pass, low pass or band pass filters depending on the type of noise signals present, and preferably comprise band pass filters having a center frequency in the range of about 100 Hz to about 1,000 Hz, although any center frequency from just above DC to about 100 kHz may be used and a wide range of the parameter Q (width of the frequency window) may also be employed as will be understood by one of skill in the art. For example, a band pass filter which passes frequencies in the range of about 950 Hz to 1,050 Hz (center frequency of 1,000 Hz and Q of 10) is adequate. Additionally, amplifiers 206 and 208 are preferably AC voltmeters.

In this configuration, the phase-detected signals can be used to detect temporal fluctuations of the piezoresponse amplitude and phase. In the case of ferroelectric materials, these temporal fluctuations correspond to fluctuations in the polarization of the material. The instantaneous phase-detected amplitude and phase are given by:

R(t)=R₀+δR(t) (1)

ø(t)=ø₀+δø(t) (2)

where the suffix 0 refers to the time-averaged value and the second term refers to temporal fluctuation or noise. Thus, sending the phase-detected amplitude and phase signals generated by demodulator 118 through filters 202 and 204 suppresses the DC (i.e. time-averaged) component of each signal, and only the fluctuating component of each signal (i.e. the noise) is detected by the amplifiers 206 and 208, which provides an rms value of the amplitude noise and phase noise.

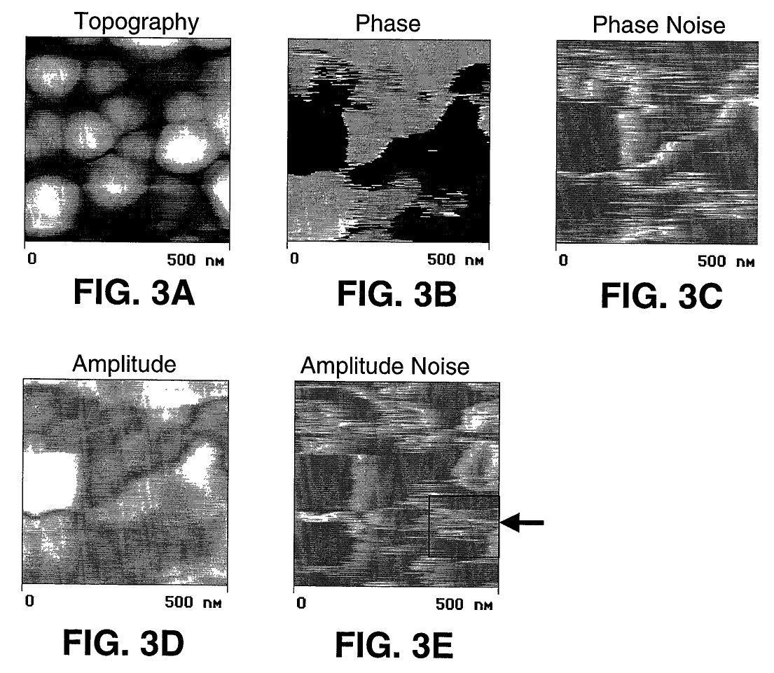

FIGS. 3A-3E show the results of a typical measurement. In this case, experiments were performed on a 250 nm thick film sample of lead zirconium titinate (“PZT”). The five panels show the topography, phase, phase noise, amplitude and amplitude noise. The topography image (FIG. 3A) is the result of standard AFM operation, given by the deflection of the cantilever as it is scanned across the surface of the film sample.

First, phase and phase noise alone are considered. FIG. 3B is a time-averaged phase image and FIG. 3C is a phase noise image. As shown in FIG. 3B, the phase has basically two values: 0° (dark) and 180° (light). The 0° regions correspond to domains with polarization pointed down and the 180° regions are domains with polarization up. As shown in FIG. 3C, the phase noise signal is clearly seen at the boundary between the domains poled up and down. This shows that the phase noise is generated at the domain wall alone and is small in the interior of a domain, independent of the sign of polarization. This is also manifested in the jaggedness of the time-averaged signal in the phase picture. In other words, the image of the noise provides a map of unstable or metastable regions of the system, which are dominantly at the domain walls.

Next, amplitude and amplitude noise are considered. FIG. 3D is a time-averaged amplitude image and FIG. 3E is an amplitude noise image. In the amplitude image of FIG. 3D, the gray scale reflects the absolute value of the amplitude regardless of its sign. Here it should be noted that the amplitude is uniform in some regions and, as shown in FIG. 3E, the noise is small in these regions, independent of its value. On the other hand, the noise is large in the regions with large amplitude variations. In other words, there is a strong correlation between spatial fluctuations and the temporal ones.

Accordingly, the noise images produced by the piezo-noise microscope of the present invention provide a map of the stable and unstable regions in the scanned area of a ferroelectric material or other piezoelectric material. The stable regions are indicated by low noise, while unstable regions are indicated by high noise. Thresholds for characterizing high noise and low noise can be assigned as desired and as will be understood by one of skill in the art. Notwithstanding, high noise is preferably characterized by several microvolts or several percent of the piezoresponse signal itself, while low noise is preferably about 1 nanovolt or any value below the detection limit of the equipment.

Comparing the phase noise image of FIG. 3C and the amplitude noise image of FIG. 3E, a very strong correlation between them is found. That is, the noise is dominantly at the domain walls where not only the phase changes sign but the amplitude also goes through a large change. Nevertheless, the correlation is not exact. A box marked by an arrow in FIG. 3E contains a band of amplitude noise that does not have a large phase noise. But the reverse situation does not occur. On inspection, it is evident that this amplitude fluctuation occurs in a region where there is no phase domain wall—that is, the net polarization is of the same sign. Hence, no phase noise exists. However, fluctuations of the same kind exist in the amplitude signal. This is a location where a majority of dipoles are of a given sign, but their number fluctuates. Therefore, the phase noise and amplitude noise give complimentary, rather than identical, information, and are both useful for locating regions of unstable polarization.

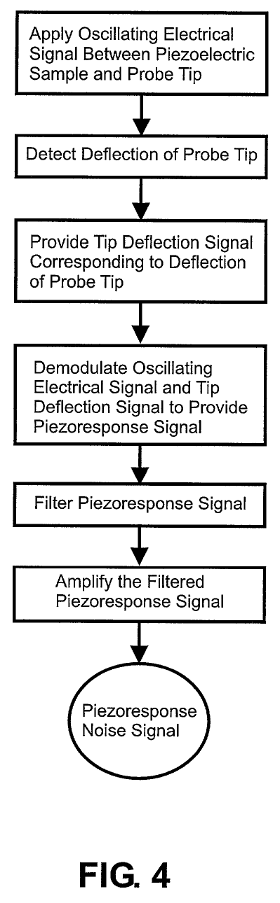

FIG. 4 is a flow diagram illustrating a method for detecting piezo-response noise in a sample of piezoelectric material using the piezo-noise microscope of the present invention and discussed above. As shown in the figure, an oscillating electrical signal is first applied between the piezoelectric sample and the probe tip of the piezo-noise microscope. This mechanically deforms the sample due to the piezoelectric effect and thereby deflects the probe tip. The deflection of the probe tip is then detected, and a tip deflection signal corresponding to the deflection of the probe tip is provided. The oscillating electrical signal and the tip deflection signal are then demodulated to provide at least a first piezoresponse signal, which is subsequently filtered and then amplified to provide a piezoresponse noise signal. It should be noted that the variations and alternatives discussed above with respect to the piezo-noise microscope of the present invention apply similarly to the method for detecting piezo-response noise of the present invention.

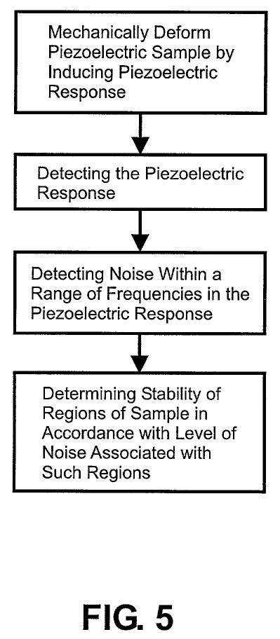

FIG. 5 is a flow diagram illustrating a method for detecting the stability of polarization in regions of a sample of piezoelectric material. As shown in the figure, a piezoelectric sample is first mechanically deformed by inducing a piezoelectric response. The piezoelectric response is then detected, and noise within a predetermined range of frequencies in the piezoelectric response is then also detected. Finally, the stability of regions of the sample is determined in accordance with the level of noise associated with such regions. This method preferably utilizes the piezo-noise microscope of the present invention as set forth above.

Accordingly, the piezo-noise microscope of the present invention is highly advantageous in comparison with standard AFMs of the prior art. In a standard AFM operating piezoresponse imaging mode, the time-averaged value of the amplitude and phase of the piezoresponse is obtained using lock-in-detection. This method is not suitable for determining long-term stability of ferroelectric domains, and would require observations over long periods of time. The advantage of the piezo-noise microscope of the present invention is that the unstable regions are immediately seen in the amplitude noise and phase noise images. This technique could also be used with any scanning probe that applies an oscillatory signal to a sample and feeds the electrical signal generated by the detected cantilever response to a broadband or lock-in amplifier. Two examples are electric force microscopy and scanning capacitance microscopy.

While there has been described and illustrated herein a piezo-noise microscope and various methods for use thereof, it will be apparent to those skilled in the art that further variations and modifications are possible without deviating from the broad teachings and spirit of the invention which shall be limited solely by the scope of the claims appended hereto.

What is claimed is:

1. A piezo-noise microscope for use in examining a sample of piezoelectric material, the piezo-noise microscope comprising:
an electrically conductive support for supporting the sample;
a probe comprising a cantilever and an electrically conductive probe tip on a free end of the cantilever, the probe tip being positionable in contact with a surface of the sample and being deflectable in response to mechanical deformation of the sample caused by a piezoelectric effect;
an oscillator electrically coupled to the support and the probe and providing an oscillating electrical signal thereto;
a tip deflection detector providing a tip deflection signal corresponding to deflection of the probe tip;
a demodulator configured to provide at least a first piezoresponse signal based on the oscillating electrical signal and the tip detection signal;
a first filter for filtering the first piezoresponse signal; and
a first amplifier for amplifying the filtered first piezoresponse signal to provide a first piezoresponse noise signal.

2. The piezo-noise microscope of claim 1, wherein the first piezoresponse signal comprises a phase-detected amplitude signal and the first piezoresponse noise signal comprises an amplitude noise signal.

3. The piezo-noise microscope of claim 1, wherein the first piezoresponse signal comprises a phase-detected phase signal and the first piezoresponse noise signal comprises a phase noise signal.

4. The piezo-noise microscope of claim 1, wherein the demodulator is further configured to provide a second piezoresponse signal based on the oscillating electrical signal and the tip detection signal, and wherein the piezo-noise microscope further comprises:
a second filter for filtering the second piezoresponse signal; and
a second amplifier for amplifying the filtered second piezoresponse signal to provide a second piezoresponse noise signal.

5. The piezo-noise microscope of claim 4, wherein the first piezoresponse signal comprises a phase-detected amplitude signal, the first piezoresponse noise signal comprises an amplitude noise signal, the second piezoresponse signal comprises a phase-detected phase signal and the second piezoresponse noise signal comprises a phase noise signal.

6. The piezo-noise microscope of claim 1, wherein the probe further comprises an optically reflective portion, and wherein the tip deflection detector comprises:
a light source directed at the reflective portion of the probe; and
a photodetector disposed so as to detect light reflected from the optically reflective portion of the probe, the photodetector providing the tip deflection signal corresponding to deflection of the probe tip as indicated by fluctuations in the reflected light.

7. The piezo-noise microscope of claim 6, wherein the light source comprises a laser.

8. The piezo-noise microscope of claim 1, wherein the demodulator includes the oscillator.

9. The piezo-noise microscope of claim 1, wherein the demodulator comprises a lock-in amplifier.

10. The piezo-noise microscope of claim 1, wherein the first amplifier comprises an AC voltmeter.

11. The piezo-noise microscope of claim 1, further comprising a controller which is operable to scan the probe tip across the surface of the sample and to correlate the first piezoresponse noise signal with the position of the probe tip on the surface of the sample to generate a noise image of the sample.

12. The piezo-noise microscope of claim 1, wherein the oscillating electrical signal has a frequency of about 10 kHz.

13. The piezo-noise microscope of claim 1, wherein the first filter comprises a band pass filter.

14. The piezo-noise microscope of claim 1, wherein the first filter comprises a band pass filter configured to attenuate all frequencies except frequencies in a range of about 950 Hz to about 1,050 Hz.

15. The piezo-noise microscope of claim 1, wherein the piezoelectric material comprises a ferroelectric material.

16. A method for detecting piezo-response noise in a sample of piezoelectric material using a piezo-noise microscope including a probe having an electrically conductive probe tip provided on a free end of a cantilever and positioned in contact with a surface of the sample, the method comprising the steps of:
applying an oscillating electrical signal between the sample and the probe tip such that the sample mechanically deforms due to a piezoelectric effect, thereby deflecting the probe tip;
detecting deflection of the probe tip;
providing a tip deflection signal corresponding to deflection of the probe tip;
demodulating the oscillating electrical signal and the tip detection signal to provide at least a first piezoresponse signal;
filtering the first piezoresponse signal; and
amplifying the filtered first piezoresponse signal to provide a first piezoresponse noise signal.

17. The method of claim 16, wherein the first piezoresponse signal comprises a phase-detected amplitude signal and the first piezoresponse noise signal comprises an amplitude noise signal.

18. The method of claim 16, wherein the first piezoresponse signal comprises a phase-detected phase signal and the first piezoresponse noise signal comprises a phase noise signal.

19. The method of claim 16, wherein the step of demodulating further comprises demodulating the oscillating electrical signal and the tip detection signal to provide a second piezoresponse signal, and wherein the method further comprises:
filtering the second piezoresponse signal; and
amplifying the filtered second piezoresponse signal to provide a second piezoresponse noise signal.

20. The method of claim 19, wherein the first piezoresponse signal comprises a phase-detected amplitude signal, the first piezoresponse noise signal comprises an amplitude noise signal, the second piezoresponse signal comprises a phase-detected phase signal and the second piezoresponse noise signal comprises a phase noise signal.

21. The method of claim 16, wherein the detecting step includes:
directing light at a reflective portion of the probe; and
producing a tip deflection signal corresponding to deflection of the probe tip as indicated by fluctuations in the light reflected from the probe.

22. The method of claim 21, wherein the light is provided by a laser.

23. The method of claim 16, wherein the amplifying step comprises passing the filtered first piezoresponse signal through an AC voltmeter.

24. The method of claim 16, further comprising the steps of scanning the probe tip across the surface of the sample and correlating the first piezoresponse noise signal with the position of the probe tip on the surface of the sample to generate a noise image of the sample.

25. The method of claim 16, wherein the oscillating electrical signal has a frequency of about 10 kHz.

26. The method of claim 16, wherein the filtering step comprises attenuating all but a predetermined range of frequencies from the signal to be filtered.

27. The method of claim 16, wherein the filtering step comprises attenuating all frequencies except frequencies in a range of about 950 Hz to about 1,050 Hz from the signal to be filtered.

28. The method of claim 16, wherein the piezoelectric material comprises a ferroelectric material.

29. A method for detecting the stability of polarization in regions of a sample of piezoelectric material, the method comprising the steps of:
mechanically deforming the sample by inducing a piezoelectric response in the sample;
detecting the piezoelectric response;
detecting noise within a predetermined range of frequencies in the piezoelectric response; and
determining the stability of regions of the sample in accordance with the level of noise associated with such regions.

30. The method of claim 29, wherein the piezoelectric material comprises a ferroelectric material.
